(19) United States
(12) Patent Application Publication
(10) Pub. No.: US 2026/0236260 A1
(43) Pub. Date: Aug. 13, 2026

(54) PROCESSOR AND COMPUTER SYSTEM

(71) Applicant: Sony Group Corporation, Tokyo (JP)

(72) Inventor: Hiromu Miyazaki, Chiba (JP)

(21) Appl. No.: 19/150,813

(22) PCT Filed: Jan. 12, 2024
(86) PCT No.: PCT/JP24/00624

§ 371 Date: Jul. 24, 2025

(30) Foreign Application Priority Data
Mar. 9, 2023 (JP) 2023-036320

(51) Int. Cl. G06F 9/30; G06F 9/34; G06F 9/38

(52) U.S. Cl. CPC G06F 9/3012; G06F 9/34; G06F 9/3861

(57) ABSTRACT

A register defined by an instruction set is disclosed. In one example, a register has a predetermined number of entries. An instruction processing unit executes an instruction specifying a virtual register having a number of entries exceeding the predetermined number as an operand. A register access control unit determines whether or not a value of an entry of the virtual register specified as the operand in a specific instruction exists in the register. In a case where it is detected that the value of the entry of the virtual register specified as the operand in the specific instruction does not exist in the register, the instruction control unit controls the instruction processing unit in such a way as to read, to the register, the value of the entry from a memory storing the value of the entry.

### TECHNICAL FIELD

The present technology relates to a processor. More particularly, the present technology relates to a processor and a computer system that execute instructions that specify registers as operands.

### BACKGROUND ART

Many processors specify a register defined by an instruction set as an operand. This register is implemented as a high-speed small-capacity storage unit. Usually, the number of entries of a register defined by an instruction set and the number of entries of a register implemented are equal. For example, in a microprocessor or the like having limited resources for an embedded system, on the other hand, it is sometimes desired to implement a register defined by an instruction set with a register of fewer entries. As such a register virtualization technique, for example, a technique has been proposed in which a data memory including a plurality of memory lines and a depth register for storing addresses corresponding to the memory lines are provided and a plurality of register sets is selectively used (see, for example, Patent Document 1).

### CITATION LIST

### Patent Document

Patent Document 1: Japanese Patent Application Laid-Open No. H10-240525

### SUMMARY OF THE INVENTION

### Problems to be Solved by the Invention

In the above-described conventional technique, a plurality of register sets is selectively used by providing a depth register. In this conventional technique, however, it is necessary to newly introduce a dedicated processor instruction and control circuit in order to virtualize registers, and there is a problem that not only significant changes in a processor architecture are involved, but also it is difficult to maintain compatibility of software.

The present technology has been made in view of such a situation, and an object thereof is to implement a register defined by an instruction set with a register of fewer entries without significantly changing a processor architecture.

### Solutions to Problems

The present technology has been made to address the above problem, and a first aspect thereof is a processor and a computer system including the processor, the processor including a register having a predetermined number of entries, an instruction processing unit that executes an instruction specifying, as an operand, a virtual register having a number of entries exceeding the predetermined number, a register access control unit that determines whether or not a value of an entry of the virtual register specified as the operand in a specific instruction exists in the register, and an instruction control unit that controls, in a case where it is detected that the value of the entry of the virtual register specified as the operand in the specific instruction does not exist in the register, the instruction processing unit in such a way as to read, to the register, the value of the entry from a memory storing the value of the entry. This brings about an effect of processing an instruction using the register having a smaller number of entries than the number of entries of the virtual register.

In addition, in the first aspect, in a case where it is detected that the value of the entry of the virtual register specified as the operand in the specific instruction does not exist in the register, the instruction control unit may interrupt the specific instruction, execute an instruction to read the value of the entry from the memory to the register, and then execute the specific instruction again. This brings about an effect of reading a necessary value from the memory to the register when processing an instruction using the register having a smaller number of entries than the number of entries of the virtual register.

In addition, in the first aspect, the instruction processing unit may include an instruction pipeline that sequentially executes the instruction with a plurality of pipeline stages, and in a case where it is detected that the value of the entry of the virtual register specified as the operand in the specific instruction does not exist in the register, the instruction control unit may temporarily flush the instruction pipeline including the specific instruction, insert into the instruction pipeline an instruction to read the value of the entry from the memory to the register, and then execute the specific instruction again. This brings about an effect of reading a necessary value from the memory to the register when processing an instruction with the instruction pipeline using the register having a smaller number of entries than the number of entries of the virtual register.

In addition, in the first aspect, the instruction processing unit may store a value of an entry that is not held in the register among values of entries of the virtual register in the memory. In this case, in a case where it is detected that the value of the entry of the virtual register specified as the operand in the specific instruction does not exist in the register, the instruction control unit may interrupt the specific instruction, execute a swap instruction to exchange the value of the entry stored in the memory and a value held in the register, and then execute the specific instruction again. This brings about an effect of reading a necessary value from the memory to the register using a swap instruction when processing an instruction using the register having a smaller number of entries than the number of entries of the virtual register.

In addition, in the first aspect, the register access control unit may include control information indicating which entry of the virtual register is held for each entry of the register, and determine whether or not the value of the entry of the virtual register specified as the operand exists in the register on the basis of the control information. In this case, the register access control unit may manage the virtual register while dividing the virtual register into a plurality of sets, and the control information may indicate which set of the virtual register is held for each entry of the register. This brings about an effect. of identifying an entry of the register when processing an instruction using the register having a smaller number of entries than the number of entries of the virtual register.

In addition, in the first aspect, the register access control unit may include an entry conversion table specifying an entry of the virtual register that can be held in the register, and determine which entry of the register the value of the entry of the virtual register specified as the operand exists in. This brings about an effect of setting corresponding entries of the virtual register and the register.

In addition, in the first aspect, the register access control unit may manage the register while dividing the register into a plurality of indices, and the entry conversion table may specify, for the virtual register, an index that can be held in the register.

This brings about an effect of facilitating management of entries in the register.

In addition, in the first aspect, the register access control unit may include history information for managing an access frequency for each entry of the register, and refer to the history information when selecting an entry of the register that is to hold the value of the entry of the virtual register. This brings about an effect of using an entry of a register whose access frequency is low.

Furthermore, in the first aspect, the register access control unit may perform management such that a subset of entries of the virtual register is always held in the register. This brings about an effect of causing the register to always hold values of the subset of the entries of the virtual register.

In addition, in the first aspect, the instruction processing unit may execute an instruction specifying a plurality of types of virtual registers as operands, and a specific entry of the register may selectively hold any value of different types of virtual registers among the plurality of types of virtual registers. This brings about an effect of sharing an entry of the register between a plurality of types of virtual registers.

### BRIEF DESCRIPTION OF DRAWINGS

FIG. 1 is a block diagram illustrating an example of configuration of a computer system in an embodiment of the present technology.

FIG. 2 is a diagram illustrating an example of configuration of a memory 200 in the embodiment of the present technology.

FIG. 3 is a diagram illustrating an example of a relationship between a register 120 and a virtual register in the first embodiment of the present technology.

FIG. 4 is a diagram illustrating an example of control information 131 in the first embodiment of the present technology.

FIG. 5 is a diagram illustrating a first specific example of the relationship between the register 120 and the virtual register in the first embodiment of the present technology.

FIG. 6 is a diagram illustrating a second specific example of the relationship between the register 120 and the virtual register in the first embodiment of the present technology.

FIG. 7 is a flowchart illustrating an example of a register reading operation of the computer system in the first embodiment of the present technology.

FIG. 8 is a timing chart illustrating an example of the register reading operation of the computer system in the first embodiment of the present technology.

FIG. 9 is a diagram illustrating an example of an entry conversion table 132 in a second embodiment of the present technology.

FIG. 10 is a diagram illustrating a first specific example of the relationship between the register 120 and the virtual register in the second embodiment of the present technology.

FIG. 11 is a diagram illustrating a second specific example of the relationship between the register 120 and the virtual register in the second embodiment of the present technology.

FIG. 12 is a diagram illustrating an example of history information 133 in the second embodiment of the present technology.

FIG. 13 is a flowchart illustrating an example of a process for changing allocation of entries of the register 120 in the second embodiment of the present technology.

FIG. 14 is a diagram illustrating a specific example of a relationship between a register 120 and a virtual register in a third embodiment of the present technology.

FIG. 15 is a diagram illustrating a first specific example of a relationship between the register 120 and the virtual register in a fourth embodiment of the present technology.

FIG. 16 is a diagram illustrating a second specific example of the relationship between the register 120 and the virtual register in the fourth embodiment of the present technology.

### MODE FOR CARRYING OUT THE INVENTION

Modes for carrying out the present technology (hereinafter referred to as embodiments) will be described hereinafter. The description will be given in the following order.
1. First Embodiment (Example of Holding Virtual Register in Corresponding Entries of Register)
2. Second Embodiment (Example of Dynamically Changing Corresponding Entries of Register)
3. Third Embodiment (Example of Dedicated Use of Some Entries of Register)
4. Fourth Embodiment (Example of Sharing Register Between Plurality of Types of Virtual Registers)

### 1. First Embodiment

### [Configuration of Computer System]

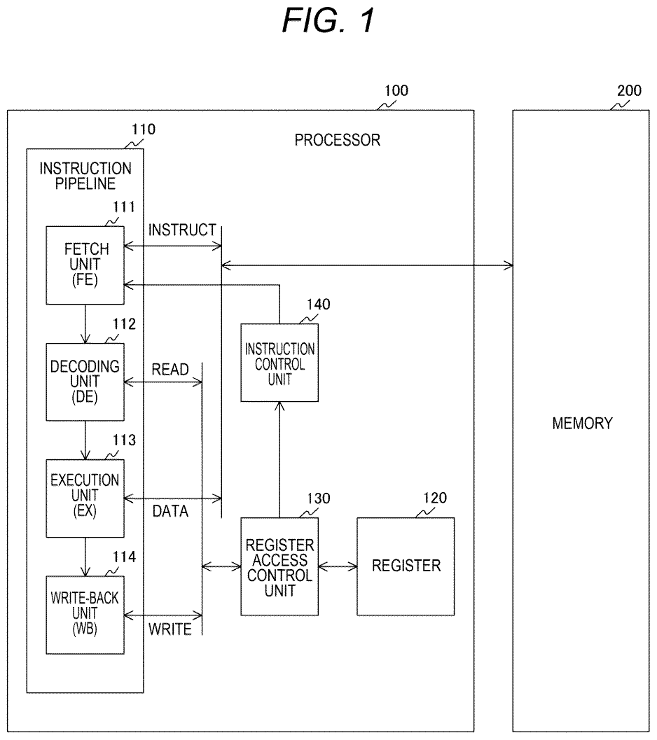

FIG. 1 is a block diagram illustrating an example of configuration of a computer system in an embodiment of the present technology. The computer system includes a processor 100 and a memory 200.

The processor 100 is a processing device that executes an instruction specifying a register as an operand. The processor 100 includes an instruction pipeline 110, a register 120, a register access control unit 130, and an instruction control unit 140.

The instruction pipeline 110 is an instruction processing unit that sequentially executes instructions in a program with a plurality of pipeline stages. The instruction pipeline 110 includes four pipeline stages, namely a fetch unit (FE: Instruction Fetch) 111, a decoding unit (DE: Instruction Decode) 112, an execution unit (EX: Execute) 113, and a write-back unit (WB: Write Back) 114. Note that the instruction pipeline 110 is an example of an instruction processing unit described in the claims.

The fetch unit 111 is a stage for reading an instruction from the memory 200. The decoding unit 112 is a stage that decodes the instruction read by the fetch unit 111 and reads values of virtual registers specified as operands from the register 120 as necessary. The execution unit 113 is a stage that executes the instruction using the values read by the decoding unit 112. The write-back unit 114 is a stage that writes back values obtained as a result of the execution by the execution unit 113 to the register 120.

The register 120 is a physical register implemented in the processor 100. In this embodiment, the physical register implemented in the processor 100 will be referred to as the register 120, and virtual registers defined in an instruction set will be referred to as virtual registers.

The register access control unit 130 is a control unit that performs control for accessing the register 120. In response to a request from the instruction pipeline 110, the register access control unit 130 determines whether or not a value of an entry of a virtual register specified as an operand in a specific instruction exists in the register 120. Therefore, the register access control unit 130 includes control information, which will be described later.

The instruction control unit 140 is a control unit that controls execution of an instruction in the instruction pipeline 110 in accordance with an instruction from the register access control unit 130.

When the register access control unit 130 detects that the value of the entry of the virtual register does not exist in the register 120, the instruction control unit 140 controls the instruction pipeline 110 in such a way as to read the value of the entry from the memory 200 that stores the value of the entry to the register 120.

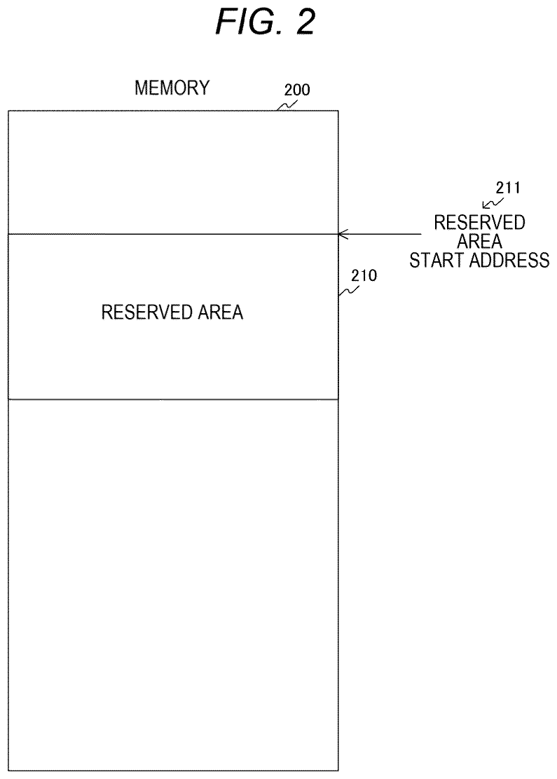

FIG. 2 is a diagram illustrating an example of configuration of the memory 200 in the embodiment of the present technology.

The memory 200 is generally a memory that stores instructions, data, and the like necessary for processing of a program. The memory 200 in this embodiment further stores, in a reserved area 210, values of virtual registers not held in the register 120. A start address 211 of the reserved area 210 is managed by the register access control unit 130 and used at a time of access between the register 120 and the memory 200. A value of the start address 211 of the reserved area 210 is determined, for example, when the processor is implemented. In this case, the value is written in a specification or the like of the processor. Alternatively, a special register may be added to store the value of the start address 211 therein. In this case, the value of the start address 211 can be changed even after the implementation of the processor.

[Relationship between Register and Virtual Register]

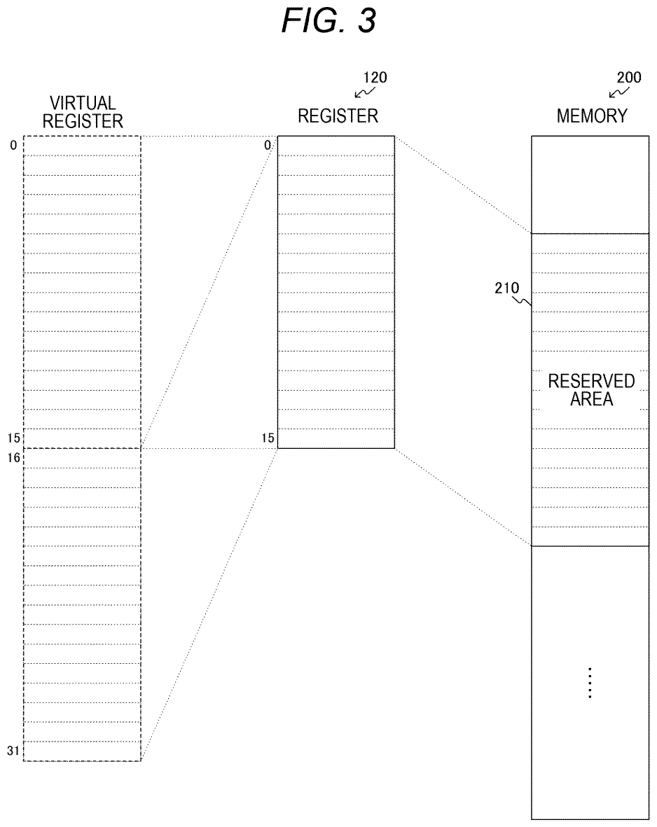

FIG. 3 is a diagram illustrating an example of a relationship between the register 120 and a virtual register in the first embodiment of the present technology.

In this example, the virtual register is divided into two sets, and values of entries of one of the sets are held in corresponding entries of the register 120.

Values of entries of the other set of entries, on the other hand, are stored in the reserved area 210 of the memory 200.

For example, a virtual register of 32 entries is divided into a first set (zeroth to fifteenth entries) and a second set (sixteenth to thirty-first entries), and a subset of the entries are associated with 16 entries of the register 120. That is, either the zeroth entry or the sixteenth entry of the virtual register is held in a zeroth entry of the register 120, and another is stored in a zeroth entry of the reserved area 210 of the memory 200. In addition, either the first entry or the seventeenth entry of the virtual register is held in a first entry of the register 120, and another is stored in a first entry of the reserved area 210 of the memory 200. Similarly, one of two entries in each of combinations of the second to fifteenth entries and the eighteenth to thirty-first entries, respectively, of the virtual register is held in second to fifteenth entries of the register 120, and another is stored in second to fifteenth entries of the reserved area 210 of the memory 200, respectively.

That is, in this example, a relative entry in each set of the virtual register is fixed for each entry of the register 120, and once a set to be held is identified, a corresponding entry of the virtual register is uniquely determined.

In a case where it is detected in the instruction pipeline 110 that a value of an entry of the virtual register specified as an operand does not exist in the register 120, the instruction is interrupted, and a value of an entry stored in the reserved area 210 of the memory 200 and a value held in the register 120 are exchanged.

For this purpose, a swap instruction that exchanges a value of a particular entry of the register 120 with a value stored in the memory 200 may be used. In a case where such an instruction is not provided in an instruction set for the processor, general load and store instructions between the memory 200 and the register 120 may be used in combination.

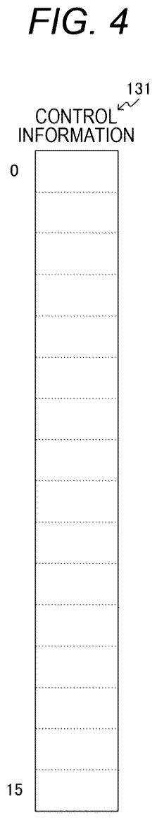

FIG. 4 is a diagram illustrating an example of control information 131 in the first embodiment of the present technology.

The control information 131 indicates which entry of the virtual register is held for each entry of the register 120. That is, each entry of the register 120 alternatively holds an entry of the virtual register.

Therefore, in a broad sense, an entry number of the virtual register can be directly specified by the control information 131. In this case, however, for a virtual register of 32 entries, control information 131 having a 5-bit width is required for each of 16 entries.

Therefore, in the following specific example, the virtual register is divided into two sets as in the above-described example, and order of entries in the sets is treated as fixed. As a result, the control information 131 may include a flag having a 1-bit width for each of the 16 entries.

Note that the control information 131 may be provided in the register access control unit 130, for example, or may be implemented as being attached to the register 120.

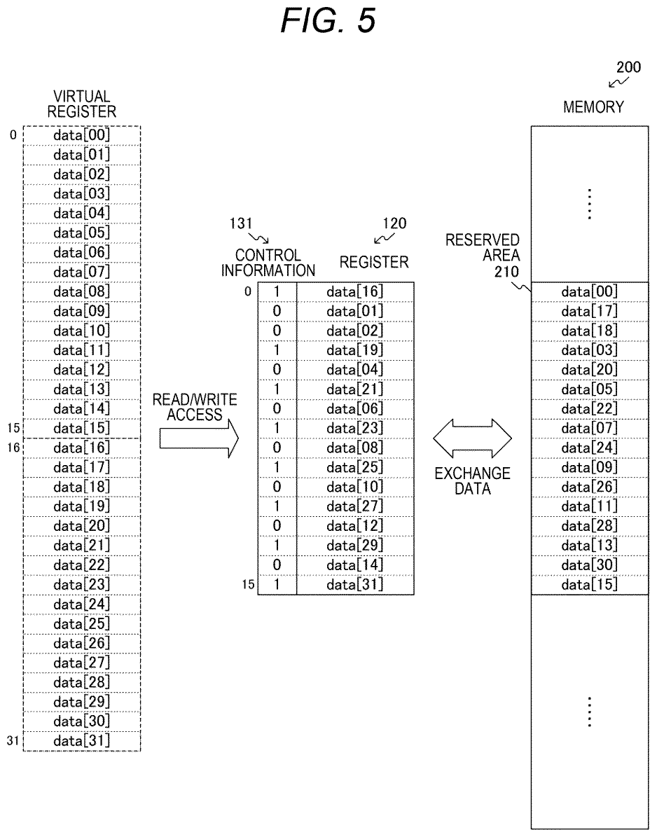

FIG. 5 is a diagram illustrating a first specific example of a relationship between the register 120 and the virtual register in the first embodiment of the present technology.

In this example, the virtual register is divided into two sets, and a flag having a 1-bit width is provided for each of 16 entries as the control information 131 to indicate which set of the virtual register is held in the entry. Specifically, in a case where the value held in the control information 131 is “0”, a value in a first set of the virtual register is held, and in a case where the value is “1”, a value in a second set of the virtual register is held in the corresponding entry of the register 120. In addition, a value in another set is stored in the corresponding entry of the reserved area 210 of the memory 200.

For example, in a case where a value of a zeroth entry of the control information 131 is “1”, “data [16]” of the sixteenth entry of the second set of the virtual register is held in the zeroth entry of the register 120. In addition, in this case, “data [00]” of the zeroth entry of the first set of the virtual registers is stored in the zeroth entry of the reserved area 210 of the memory 200.

At this time, in a case where an access occurs in the sixteenth entry of the virtual register in the instruction pipeline 110, reading and writing are performed on the zeroth entry of the register 120. In a case where an access to the zeroth entry of the virtual register occurs in the instruction pipeline 110, on the other hand, a process for exchanging values between the zeroth entry of the register 120 and the zeroth entry of the reserved area 210 of the memory 200 is performed, and then reading is performed on the zeroth entry of the register 120.

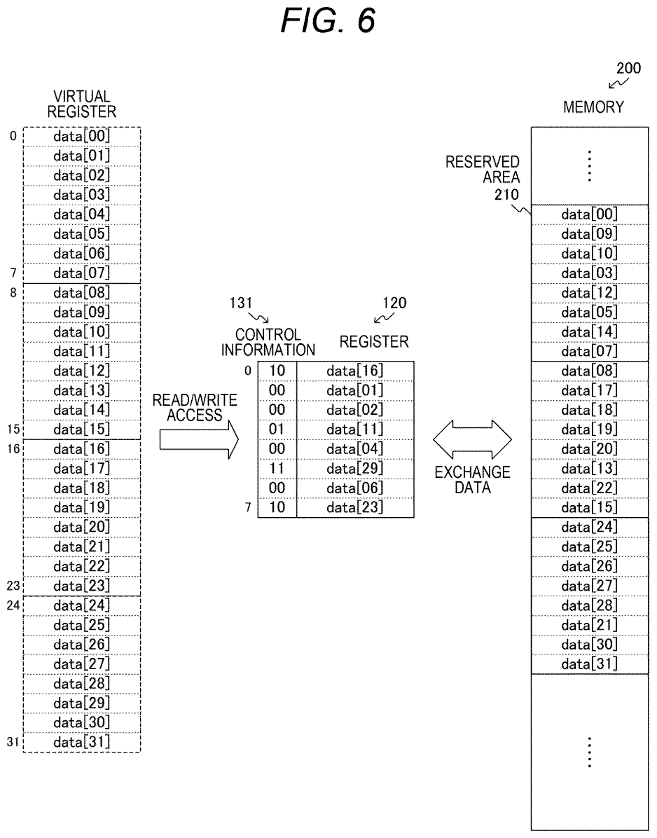

FIG. 6 is a diagram illustrating a second specific example of a relationship between the register 120 and the virtual register in the first embodiment of the present technology.

In this example, the virtual register is divided into four sets, and a flag having a 2-bit width is provided for each of 8 entries as the control information 131 to indicate which set of the virtual register is held in the entry. Specifically, in a case where the value held in the control information 131 is “00”, a value in a zeroth set of the virtual register is held, in a case where the value is “01”, a value in a first set of the virtual register is held, in a case where the value is “10”, a value in a second set of the virtual register is held, and in a case where the value is “11”, a value in a third set of the virtual resister is held in the corresponding entry of the register 120. In addition, a value in another set is stored in the three corresponding entry of the reserved area 210 of the memory 200.

For example, in a case where a value of the zeroth entry of the control information 131 is “10”, “data [16]” of the sixteenth entry of the second set of the virtual register is held in the zeroth entry of the register 120. In addition, in this case, “data [00]” of the zeroth entry of a zeroth set of the virtual register is stored in the zeroth entry of the reserved area 210 of the memory 200, “data [08]” of the zeroth entry of the first set of virtual register is stored in the eighth entry of the reserved area 210 of the memory 200, and “data [24] ” of the zeroth entry of the third set of virtual registers is stored in the twenty-fourth entry of the reserved area 210 of the memory 200.

At this time, in a case where an access occurs in the sixteenth entry of the virtual register in the instruction pipeline 110, reading and writing are performed on the zeroth entry of the register 120. In a case where an access to the eighth entry of the virtual register occurs in the instruction pipeline 110, on the other hand, a process for exchanging values between the zeroth entry of the register 120 and the eighth entry of the reserved area 210 of the memory 200 is performed, and then reading is performed on the zeroth entry of the register 120.

### [Operation]

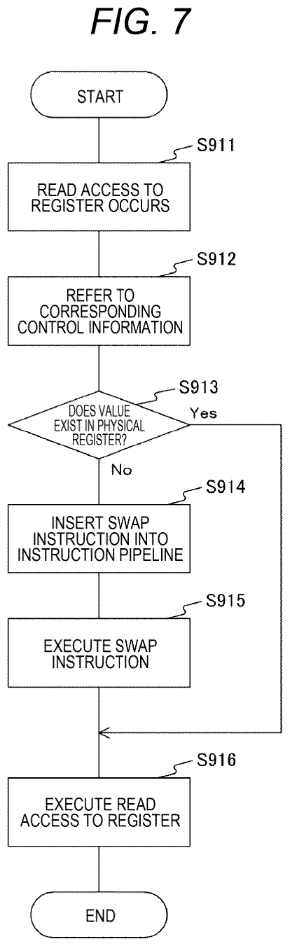

FIG. 7 is a flowchart illustrating an example of a register reading operation of the computer system in the first embodiment of the present technology. Note that a register write operation can be similarly performed.

When a read access to a virtual register specified as an operand in the instruction pipeline 110 occurs (step S911), the control information 131 regarding a corresponding entry is referred to (step S912). It is then determined, on the basis of the control information 131 referred to, whether or not a value of the virtual register exists in the register 120 (step S913).

In a case where it is determined as a result that the value of the virtual register does not exist in the register 120 (step S913: No), the instruction control unit 140 interrupts an instruction including the read access and inserts a swap instruction into the instruction pipeline 110 (step S914). As a result, the instruction pipeline 110 executes the swap instruction to interchange values of corresponding entries between the register 120 and the reserved area 210 of the memory 200 (step S915). Note that in a case where it is determined that the value of the virtual register exists in the register 120 (step S913: Yes), such a swap instruction is not executed.

The instruction pipeline 110 then resumes the instruction including the interrupted read access, and executes the read access to the register 120 (step S916).

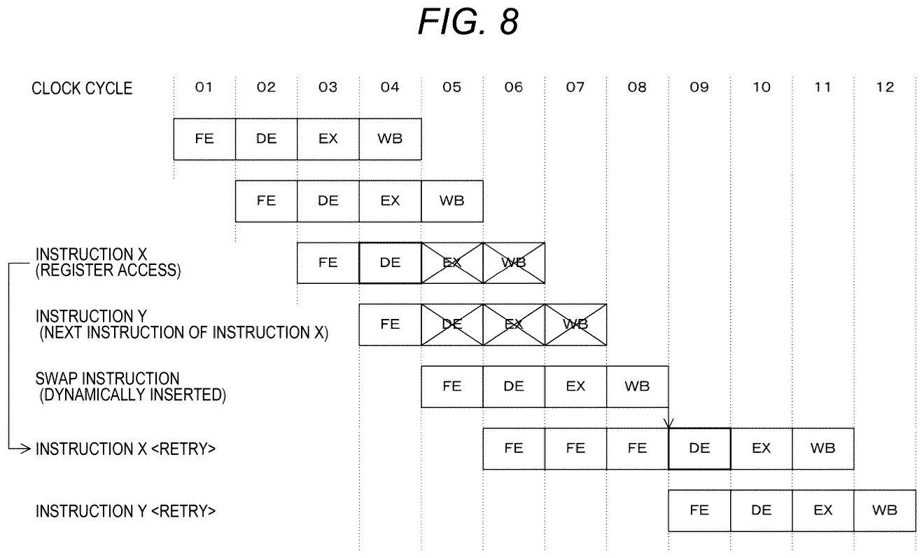

FIG. 8 is a timing chart illustrating an example of the register reading operation of the computer system in the first embodiment of the present technology.

Here, the above-described four pipeline stages are assumed. It is assumed that instructions are sequentially executed one by one from a clock cycle “01”, and an instruction X is input to the fetch unit 111 in a clock cycle “03”. For this instruction X, in a clock cycle “04”, the decoding unit 112 attempts to read a value of a virtual register specified as an operand.

In this example, it is assumed that the value of the virtual register specified as the operand of the instruction X does not exist in the register 120. Therefore, in a clock cycle “05”, the instruction control unit 140 temporarily flushes the instruction pipeline 110. As a result, processing of the instruction X and an instruction Y, which is a next instruction, is canceled. The instruction control unit 140 then dynamically inserts a swap instruction into the instruction pipeline 110. Following this swap instruction, in a clock cycle “06” the instruction X that has just been flushed is again injected into the instruction pipeline 110. The instruction X, however, remains in the fetch unit 111 until an intended value of the instruction X is prepared in the register 120.

When the swap instruction writes a result thereof to the register 120 in a clock cycle “08”, the instruction X reads, from the register 120, the value of the virtual register specified as the operand of the instruction X in a clock cycle “09”. An instruction Y, which is the next instruction of the instruction X, is also processed by the fetch unit 111 in the clock cycle “09”. Subsequent instructions are thus sequentially executed.

As described above, in the first embodiment of the present technology, a value not held in the register 120 is stored in the reserved area 210 of the memory 200, and a virtual register exceeding size of the register 120 is handled as an instruction set. Therefore, the control information 131 indicating which entry of the virtual register is held is provided for each entry of the register 120. As a result, a register defined by an instruction set can be implemented with the register 120 with fewer entries without significantly changing a processor architecture.

That is, in the first embodiment, by using the existing memory 200 and memory operation instructions, the register 120 can be virtualized while minimizing additional control circuitry. Furthermore, by dynamically inserting a swap instruction into the instruction pipeline 110, it becomes unnecessary to change existing software or an instruction set, so that compatibility of software can be maintained and software development costs can be reduced.

### 2. Second Embodiment

In the above-described first embodiment, the arrangement in the register 120 with respect to the entries of the virtual register is fixed. In a second embodiment, on the other hand, an entry conversion table is provided, and the arrangement in the register 120 can be dynamically changed. Note that basic configuration of the computer system is similar to that in the above-described first embodiment, and detailed description thereof is omitted.

### [Entry Conversion Table]

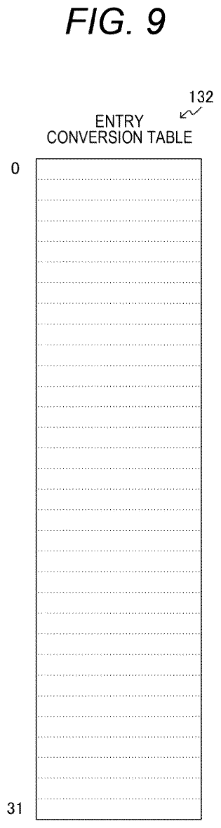

FIG. 9 is a diagram illustrating an example of an entry conversion table 132 in the second embodiment of the present technology.

The entry conversion table 132 specifies entries that can be held in the register 120 in correspondence with entries of the virtual register. Therefore, in a broad sense, an entry number of the register 120 can be directly specified. In this case, however, the entry conversion table 132 having a 4-bit width is required for each of 32 entries with respect to the register 120 of 16 entries in the above-described example. Therefore, in the following specific example, the register 120 is divided into four indices each including four entries, and an index of the register 120 is also specified for every four entries of the virtual register.

Note that the entry conversion table 132 is provided in the register access control unit 130, for example, and the register access control unit 130 specifies corresponding entries in the register 120 on the basis of the entry conversion table 132.

[Relationship between Register and Virtual Register]

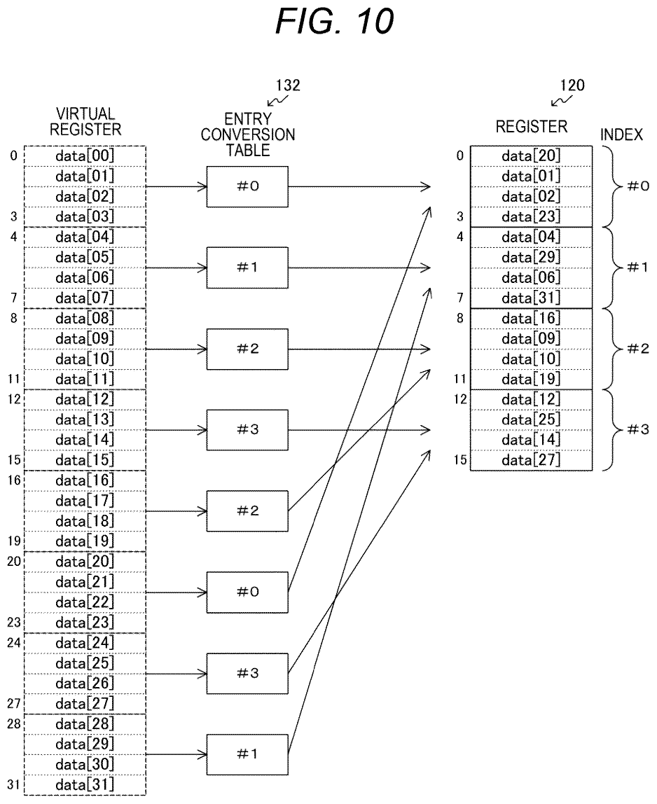

FIG. 10 is a diagram illustrating a first specific example of a relationship between the register 120 and the virtual register in the second embodiment of the present technology.

In this example, the register 120 is divided into four indices each including four entries, and an index of the register 120 is also specified for every four entries of the virtual register. That is, in the first specific example, the entry conversion table 132 includes eight entries each having a 2-bit width and specifying an index of the register 120.

As a result, the virtual register can specify the arrangement in the register 120 for every four entries. Order in indices, however, is uniquely fixed. For example, “data [00]” of the zeroth entry of the virtual register is arranged in the zeroth entry of the register 120 in the case of an index #0, in the fourth entry of the register 120 in the case of an index #1, in the eighth entry of the register 120 in the case of an index #2, and in the twelfth entry of the register 120 in the case of an index #3.

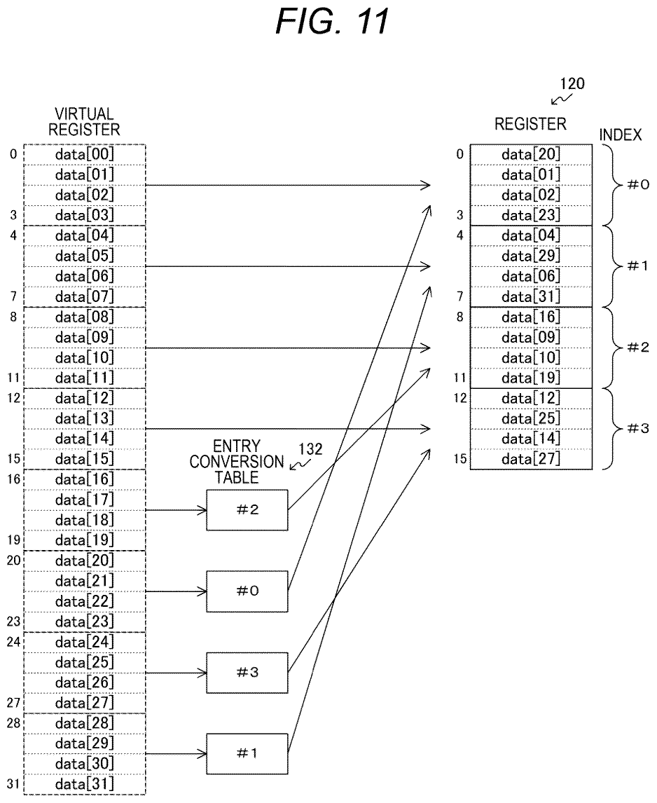

FIG. 11 is a diagram illustrating a second specific example of the relationship between the register 120 and the virtual register in the second embodiment of the present technology.

In this example, entry conversion is not performed for a first half of the virtual register but performed only for a second half of the virtual register. Therefore, in the second specific example, it is sufficient that the entry conversion table 132 includes four entries each having a 2-bit width and specifying an index of the register 120, that is, it is sufficient for the entry conversion table 132 to have half the size in the first specific example described above.

As described above, in the second embodiment, the arrangement in the register 120 can be specified by providing the entry conversion table 132. In order to dynamically change allocation of entries using this mechanism, history information can be used as follows.

### [History Information]

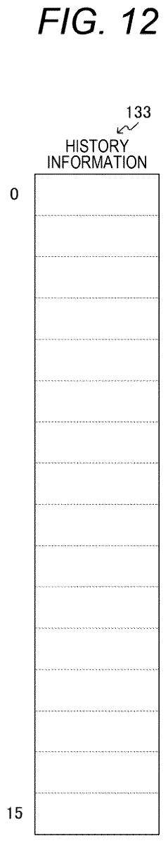

FIG. 12 is a diagram illustrating an example of history information 133 in the second embodiment of the present technology.

The history information 133 manages an access frequency for each entry of the register 120. The history information 133 can hold a value “1” in a case where an access to each entry of the register has occurred in a predetermined period, and a value “0” in a case where such an access has not occurred, on the assumption of, for example, a flag having a width of 1 bit. Alternatively, for example, a value obtained by counting the number of accesses to each entry of the register 120 in a predetermined period may be used.

Note that the history information 133 is provided, for example, in the register access control unit 130. The register access control unit 130 performs exchange with another index by referring to the history information 133. Assuming that a flag having a 1-bit width is used as the value of the history information 133, the register access control unit 130 refers to the value of the history information 133 to select a first found entry that has not been accessed in the predetermined period, and performs exchange with another index. Furthermore, assuming that the number of accesses is counted as the value of the history information 133, the register access control unit 130 selects an entry of the register 120 having a low access frequency, and performs exchange with another index.

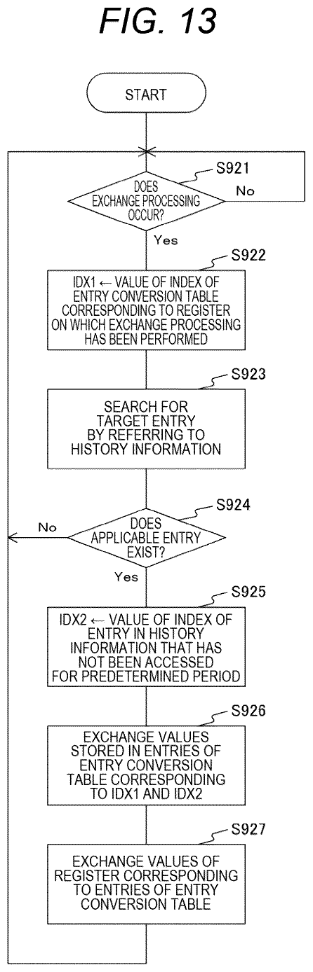

FIG. 13 is a flowchart illustrating an example of a process for changing the allocation of entries of the register 120 in the second embodiment of the present technology.

In a case where data exchange processing occurs between the register 120 and the reserved area 210 of the memory 200 (step S921: Yes), a value of an index of the entry conversion table 132 corresponding to the register 120 on which the exchange processing has been performed is held as IDX1 (step S922).

Next, a target entry is searched for with reference to the history information 133 regarding each entry (step S923). At this time, assuming a flag having a 1-bit width as a value of the history information 133, for example, an entry that has not been accessed for a certain period is searched for. Furthermore, assuming that the number of accesses is counted as the value of the history information 133, for example, an entry with the lowest access frequency is searched for. In a case where, as a result, a target entry is found (step S924: Yes), a value of an index of the entry is held as IDX2 (step S925). Note that in a case of an entry having the same access frequency, it is not necessary to perform exchange, and the entry is not applicable as a target entry.

The values stored in the entries of the entry conversion table 132 corresponding to IDX1 and IDX2 obtained in this manner are exchanged (step S926). The values stored in the entries of the register 120 corresponding to the entries of the entry conversion table 132 are then exchanged (step S927). The processing in step S927 can be achieved by dynamically inserting an instruction for exchanging data in the entries of the register 120 into the instruction pipeline.

By repeatedly executing the above-described exchange algorithm, the allocation of entries is maintained in an optimal state reflecting characteristics of a program and the like, and it is possible to avoid an entry conflict in the register 120.

As described above, according to the second embodiment, it is possible to avoid a conflict in the register 120 by dynamically changing the arrangement in the register 120 using the entry conversion table 132 on the basis of the history information 133.

### 3. Third Embodiment

In an instruction set architecture, in a case where special registers such as a stack pointer and a return address are defined as virtual registers, a frequency of occurrence of an entry conflict can be high because such virtual registers are frequently used in programs. In addition, in a case where a register whose use frequency will be high is known in advance, it is desirable not to share entries of the virtual register with other entries. Therefore, in a third embodiment, it is assumed that only some entries of the register 120 are shared between virtual registers. Note that basic configuration of the computer system is similar to that in the above-described first embodiment, and detailed description thereof is omitted.

[Relationship between Register and Virtual Register]

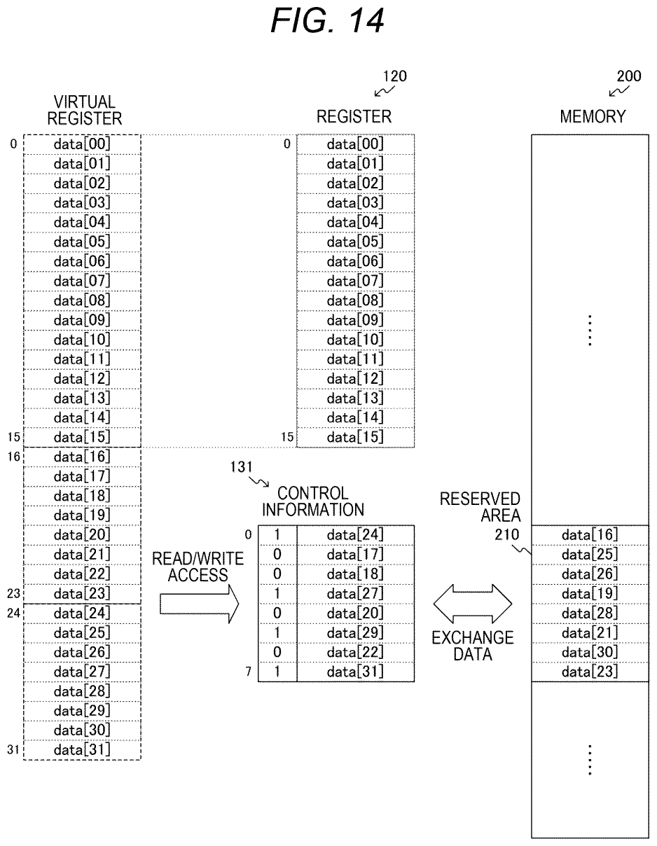

FIG. 14 is a diagram illustrating a specific example of a relationship between the register 120 and the virtual register in the third embodiment of the present technology.

In this example, the virtual register is divided into a first half (zeroth to fifteenth entries) and a second half (sixteenth to thirty-first entries), and the second half is further divided into two sets (sixteenth to twenty-third entries and twenty-fourth to thirty-first entries). Furthermore, as the register 120, a fixed register of 16 entries and a shared register of 8 entries are provided.

The first half of the virtual register is fixedly allocated to a fixed register of the register 120 and is not shared with other virtual registers. As a result, values of entries in the first half of the virtual register are managed in such a way as to be always held in the fixed register of the register 120. That is, the fixed register of the register 120 is dedicated to the entries in the first half of the virtual register.

The second half of the virtual register, on the other hand, is alternatively held in the shared register of the register 120. Therefore, the control information 131 is provided only for the shared register of the register 120, and is unnecessary for the fixed register of the register 120. Note that the control information 131 used for the shared register of the register 120 is similar to that in the first embodiment described above, and detailed description thereof is omitted.

As described above, according to the third embodiment, it is possible to avoid a conflict between entries of a virtual register by not sharing the register 120 whose use frequency is high in a program.

### 4. Fourth Embodiment

Some processors assume a plurality of types of registers as an instruction set. For example, a general-purpose register (GPR) and a vector register (VR) may be separately provided. In a fourth embodiment, it is assumed that such a plurality of different types of registers are allocated to the register 120 as virtual registers and shared. Note that basic configuration of the computer system is similar to that in the above-described first embodiment, and detailed description thereof is omitted.

[Relationship between Register and Plurality of Types of Virtual Registers]

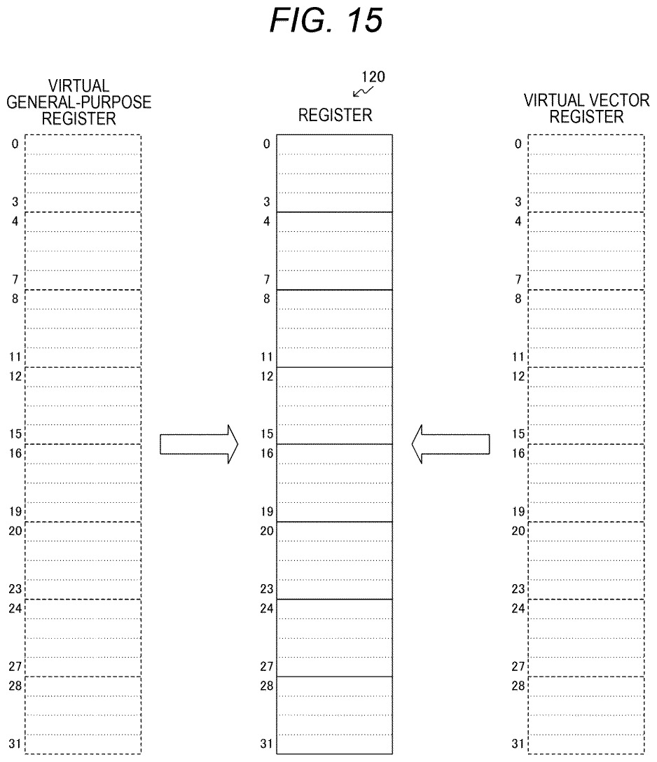

FIG. 15 is a diagram illustrating a first specific example of a relationship between the register 120 and the virtual register in the fourth embodiment of the present technology.

In this example, each of 32 entries of the register 120 holds a value of a corresponding entry of either a virtual general-purpose register or a virtual vector register, each of which has 32 entries. That is, the register 120 is shared by the virtual general-purpose registers and the virtual vector registers. As a result, in a case where a use rate of entries of a plurality of types of registers such as a virtual general-purpose register and a virtual vector register is not high, it is possible to efficiently share the register 120 and execute programs.

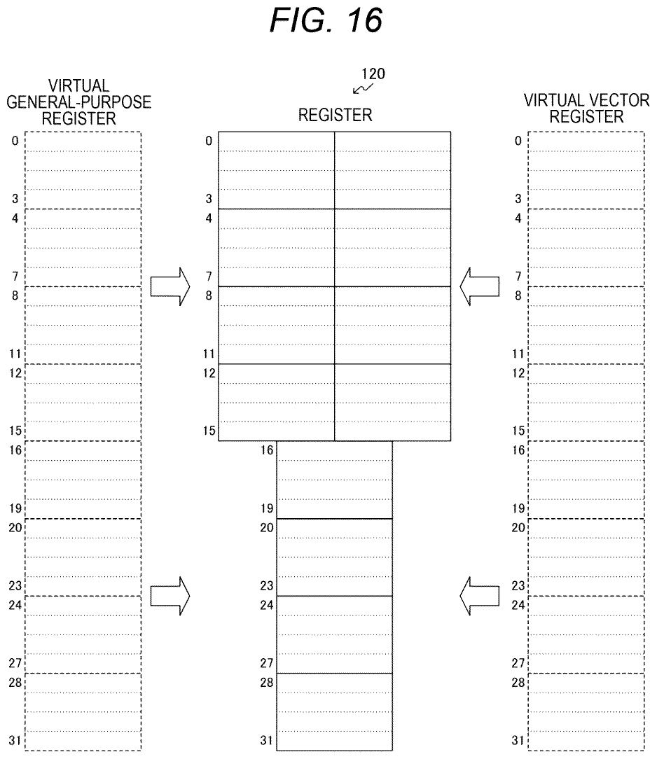

FIG. 16 is a diagram illustrating a second specific example of the relationship between the register 120 and the virtual register in the fourth embodiment of the present technology.

In this example, entries are not shared for first halves (zeroth to fifteenth entries) of the virtual general-purpose register and the virtual vector register, and the register 120 is provided separately. The register 120, on the other hand, is shared for second halves (sixteenth to thirty-first entries) of the virtual general-purpose register and the virtual vector register. That is, the register 120 can be partially shared in this manner.

As described above, according to the fourth embodiment, by sharing entries of the register 120 between a plurality of types of virtual registers, it is possible to execute a program while reducing hardware resources and maintaining execution performance.

Note that the embodiments described above are examples for embodying the present technology, and the matters in the embodiments and the matters specifying the invention in the claims have correspondences. Similarly, the respective matters specifying the invention in the claims and the respective matters with the same names in the embodiments of the present technology have correspondence relationships. The present technology, however, is not limited to the embodiments, and can be embodied by applying various kinds of modification to the embodiments without departing from the scope of the present technology.

Furthermore, the procedures described in the above-described embodiments may be considered as a method including a series of procedures and may be considered as a program for allowing a computer to execute the series of procedures and a storage medium that stores the program. As this storage medium, for example, a compact disc (CD), a MiniDisc (MD), a digital versatile disc (DVD), a memory card, a Blu-ray (registered trademark) disc, and the like can be used.

Note that the effects described in this specification are illustrative only and not limitative, and there may also be other effects.

Note that the present technology can also have the following configurations.

(1) A processor including:
a register having a predetermined number of entries;
an instruction processing unit that executes an instruction specifying, as an operand, a virtual register having a number of entries exceeding the predetermined number;
a register access control unit that determines whether or not a value of an entry of the virtual register specified as the operand in a specific instruction exists in the register; and
an instruction control unit that controls, in a case where it is detected that the value of the entry of the virtual register specified as the operand in the specific instruction does not exist in the register, the instruction processing unit in such a way as to read, to the register, the value of the entry from a memory storing the value of the entry.

(2) The processor according to (1), in which
in a case where it is detected that the value of the entry of the virtual register specified as the operand in the specific instruction does not exist in the register, the instruction control unit interrupts the specific instruction, executes an instruction to read the value of the entry from the memory to the register, and then executes the specific instruction again.

(3) The processor according to (1), in which
the instruction processing unit includes an instruction pipeline that sequentially executes the instruction with a plurality of pipeline stages, and
in a case where it is detected that the value of the entry of the virtual register specified as the operand in the specific instruction does not exist in the register, the instruction control unit temporarily flushes the instruction pipeline including the specific instruction, inserts into the instruction pipeline an instruction to read the value of the entry from the memory to the register, and then executes the specific instruction again.

(4) The processor according to any one of (1) to (3), in which
the instruction processing unit stores a value of an entry that is not held in the register among values of entries of the virtual register in the memory.

(5) The processor according to (4), in which
in a case where it is detected that the value of the entry of the virtual register specified as the operand in the specific instruction does not exist in the register, the instruction control unit interrupts the specific instruction, executes a swap instruction to exchange the value of the entry stored in the memory and a value held in the register, and then executes the specific instruction again.

(6) The processor according to any one of (1) to (5), in which
the register access control unit includes control information indicating which entry of the virtual register is held for each entry of the register, and determines whether or not the value of the entry of the virtual register specified as the operand exists in the register on the basis of the control information.

(7) The processor according to (6), in which
the register access control unit manages the virtual register while dividing the virtual register into a plurality of sets, and
the control information indicates which set of the virtual register is held for each entry of the register.

(8) The processor according to any one of (1) to (7), in which
the register access control unit includes an entry conversion table specifying an entry of the virtual register that can be held in the register, and determines which entry of the register the value of the entry of the virtual register specified as the operand exists in.

(9) The processor according to (8), in which
the register access control unit manages the register while dividing the register into a plurality of indices, and
the entry conversion table specifies, for the virtual register, an index that can be held in the register.

(10) The processor according to (8) or (9), in which
the register access control unit includes history information for managing an access frequency for each entry of the register, and refers to the history information when selecting an entry of the register that is to hold the value of the entry of the virtual register.

(11) The processor according to any one of (1) to (10), in which
the register access control unit performs management such that a subset of entries of the virtual register is always held in the register.

(12) The processor according to any one of (1) to (11), in which
the instruction processing unit executes an instruction specifying a plurality of types of virtual registers as operands, and
a specific entry of the register selectively holds any value of different types of virtual registers among the plurality of types of virtual registers.

(13) A computer system including:
a register having a predetermined number of entries;
an instruction processing unit that executes an instruction specifying, as an operand, a virtual register having a number of entries exceeding the predetermined number;
a memory that stores a value of a specific entry of the virtual register;
a register access control unit that determines whether or not a value of an entry of the virtual register specified as the operand in a specific instruction exists in the register; and
an instruction control unit that controls, in a case where it is detected that the value of the entry of the virtual register specified as the operand in the specific instruction does not exist in the register, the instruction processing unit in such a way as to read, to the register, the value of the entry from a memory storing the value of the entry.

### REFERENCE SIGNS LIST

100 Processor
110 Instruction pipeline
111 Fetch unit (FE: Instruction Fetch)
112 Decoding unit (DE: Instruction Decode)
113 Execution unit (EX: Execute)
114 Write-back (WB: Write Back) unit
120 Register
130 Register access control unit
131 Control information
132 Entry conversion table
133 History information
140 Instruction control unit
200 Memory
210 Reserved area
211 Start address of reserved area

1. A processor comprising:
a register having a predetermined number of entries;
an instruction processing unit that executes an instruction specifying, as an operand, a virtual register having a number of entries exceeding the predetermined number;
a register access control unit that determines whether or not a value of an entry of the virtual register specified as the operand in a specific instruction exists in the register; and
an instruction control unit that controls, in a case where it is detected that the value of the entry of the virtual register specified as the operand in the specific instruction does not exist in the register, the instruction processing unit in such a way as to read, to the register, the value of the entry from a memory storing the value of the entry.

2. The processor according to claim 1, wherein
in a case where it is detected that the value of the entry of the virtual register specified as the operand in the specific instruction does not exist in the register, the instruction control unit interrupts the specific instruction, executes an instruction to read the value of the entry from the memory to the register, and then executes the specific instruction again.

3. The processor according to claim 1, wherein
the instruction processing unit includes an instruction pipeline that sequentially executes the instruction with a plurality of pipeline stages, and
in a case where it is detected that the value of the entry of the virtual register specified as the operand in the specific instruction does not exist in the register, the instruction control unit temporarily flushes the instruction pipeline including the specific instruction, inserts into the instruction pipeline an instruction to read the value of the entry from the memory to the register, and then executes the specific instruction again.

4. The processor according to claim 1, wherein
the instruction processing unit stores a value of an entry that is not held in the register among values of entries of the virtual register in the memory.

5. The processor according to claim 4, wherein
in a case where it is detected that the value of the entry of the virtual register specified as the operand in the specific instruction does not exist in the register, the instruction control unit interrupts the specific instruction, executes a swap instruction to exchange the value of the entry stored in the memory and a value held in the register, and then executes the specific instruction again.

6. The processor according to claim 1, wherein
the register access control unit includes control information indicating which entry of the virtual register is held for each entry of the register, and determines whether or not the value of the entry of the virtual register specified as the operand exists in the register on a basis of the control information.

7. The processor according to claim 6, wherein
the register access control unit manages the virtual register while dividing the virtual register into a plurality of sets, and
the control information indicates which set of the virtual register is held for each entry of the register.

8. The processor according to claim 1, wherein
the register access control unit includes an entry conversion table specifying an entry of the virtual register that can be held in the register, and determines which entry of the register the value of the entry of the virtual register specified as the operand exists in.

9. The processor according to claim 8, wherein
the register access control unit manages the register while dividing the register into a plurality of indices, and
the entry conversion table specifies, for the virtual register, an index that can be held in the register.

10. The processor according to claim 8, wherein
the register access control unit includes history information for managing an access frequency for each entry of the register, and refers to the history information when selecting an entry of the register that is to hold the value of the entry of the virtual register.

11. The processor according to claim 1, wherein
the register access control unit performs management such that a subset of entries of the virtual register is always held in the register.

12. The processor according to claim 1, wherein
the instruction processing unit executes an instruction specifying a plurality of types of virtual registers as operands, and
a specific entry of the register selectively holds any value of different types of virtual registers among the plurality of types of virtual registers.

13. A computer system comprising:
a register having a predetermined number of entries;
an instruction processing unit that executes an instruction specifying, as an operand, a virtual register having a number of entries exceeding the predetermined number;
a memory that stores a value of a specific entry of the virtual register;
a register access control unit that determines whether or not a value of an entry of the virtual register specified as the operand in a specific instruction exists in the register; and
an instruction control unit that controls, in a case where it is detected that the value of the entry of the virtual register specified as the operand in the specific instruction does not exist in the register, the instruction processing unit in such a way as to read, to the register, the value of the entry from a memory storing the value of the entry.
